(19) United States
(12) Patent Application Publication
(10) Pub. No.: US 2006/0119457 A1
(43) Pub. Date: Jun. 8, 2006

(54) Micro-switch

(75) Inventors: Hsin-Chang Tsai, Taoyuan Hsien (TW); Chia-Hua Chu, Taoyuan Hsien (TW); Horng-Jou Wang, Taoyuan Hsien (TW); Tai-Kang Shing, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/283,991

(22) Filed: Nov. 22, 2005

(30) Foreign Application Priority Data
Dec. 2, 2004 (TW) 93137193

(51) Int. Cl. H01H 51/22

(52) U.S. Cl. 335/78

(57) ABSTRACT

A micro-switch. The micro-switch comprises at least one base, at least one fixed portion, and at least one switch component. The base comprises at least one first terminal and at least one first drive unit. The fixed portion is protruded higher than the base. The switch component comprises at least one deflection structure and at least one reverse structure. The deflection structure comprises at least one second terminal and at least one second drive unit. The second terminal corresponds to the first terminal and the second drive unit corresponds to the first drive unit. The reverse structure comprises one end connected to the fixed portion and another end connected to the deflection structure.

### BACKGROUND

The invention relates to a micro-switch, and in particular to a micro signal switch operated by deflection and reverse.

Current electronic products are required to be as compact as possible. Thus, a micro-switch therein must also be compact, such as a radio frequency (RF) module with micromechanical structure for a mechanical switch. Micromechanical switches comprise cantilever and bridge types.

As shown in FIG. 1, a conventional cantilever switch 100 comprises a base 102 and a cantilever 104 hung on the base 102. The cantilever 104 comprises an upper drive electrode 106 and a contact electrode 110. The base 102 comprises a lower drive electrode 108 and a signal electrode 112. When the drive electrodes 106 and 108 are electrified, the drive electrodes 106 and 108 attract each other such that the cantilever 104 moves vertical downward to electrically connect the electrodes 110 and 112. When the drive electrodes 106 and 108 are not electrified, the attractive force therebetween is disappeared. The cantilever 104 moves vertical upward by elastic restorative force such that the electrodes 110 and 112 separate from each other.

Since the cantilever 104 of the cantilever switch 100 has high elastic restorative force, the attractive force between the drive electrodes 106 and 108 should be greater than the elastic restorative force of the cantilever 104 to connect the electrodes 110 and 112. Thus, the cantilever switch 100 requires higher driving power and longer switching time.

As shown in FIG. 2, the bridge switch 200 comprises a base 202 and a U-shaped bridge structure 204 disposed on the base 202. The bridge structure 204 comprises upper drive electrodes 206a and 206b and a contact electrode 201 disposed therebetween. The base 202 comprises lower electrodes 208a and 208b and a signal electrode 212 disposed therebetween. When the drive electrodes 206a, 206b, 208a, and 208b are electrified, attraction is generated between the drive electrodes 206a and 206b and the drive electrodes 208a and 208b such that a central portion of the bridge structure 104 moves vertical downward to electrically connect the electrodes 210 and 212. When the drive electrodes 206a, 206b, 208a, and 208b are not electrified, attraction is disappeared. The bridge structure 204 is vertical upward restored by elastic restorative force such that the electrodes 210 and 212 are separated.

Thus, the bridge structure 204 has stronger elastic restorative force. Thus, the drive electrodes 206a, 206b, 208a, and 208b require higher attraction therebetween to connect the electrodes 210 and 212. Although the bridge switch 200 has a shorter switching off time, but requires longer connection time and higher driving power.

Hence, conventional micromechanical switches switching signals by a lever method requires a longer switching time and a higher driving power. Since current requirements demand that the micromechanical switche has a shorter switching time, the described disadvantages become a technological bottleneck.

### SUMMARY

Embodiments of the invention provide a micro-switch to eliminate the described shortcomings and to reduce a switching time and a driving power.

A micro-switch of an embodiment of the invention comprises at least one base, at least one fixed portion, and at least one switch component. The base comprises at least one first terminal and at least one first drive unit. The fixed portion is protruded higher than the base. One side of the fixed portion is not parallel to the base. The switch component comprises at least one deflection structure and at least one reverse structure. The deflection structure comprises at least one second terminal and at least one second drive unit. The second terminal corresponds to the first terminal and the second drive unit corresponds to the first drive unit. The reverse structure comprises one end connected to the fixed portion, and other end connected to the deflection structure. The deflection structure and the reverse structure are not parallel.

Further provided is a micro-switch comprising at least one base, at least one fixed portion, and at least one switch component. The fixed portion is protruded from the base. One side of the fixed portion is not parallel to the base. The switch component comprises at least one deflection structure and at least one reverse structure with one end connected to the side of the fixed portion, and the other end connected to the deflection structure. The deflection structure and the reverse structure are not parallel.

The switch component with the deflection and reverse structures is L-shaped, T-shaped, X-shaped, #-shaped, ≠-shaped, or arc-shaped. The first terminal contacts the second terminal by rotating, swinging, or simultaneously rotating and swinging the switch component. The switch component is driven by an electrostatic method, an electro-thermal method, an electromagnetic method, a piezoelectric method, or a fluid method. When the first terminal contacts the second terminal, at least one electrical signal, magnetic signal, or electromagnetic signal is transmitted between the first terminal and the second terminal.

In the micro-switch, the switch component further comprises at least one auxiliary structure, formed on the deflection structure, the reverse structure, or both. The auxiliary structure comprises a groove, a ripple, or, a hole. The deflection structure or the reverse structure has a linear, I-shaped, ripple-shaped, or O-shaped cross section. The deflection structure or the reverse structure is shaped as polygonal, round, polygonal with at least one curved side, regular or irregular.

When the quantity of the deflection structures or the reverse structure is more than two, the deflection structures or the reverse structure are symmetrical, asymmetrical, or partially symmetrical. The micro-switch is an electro-signal switch, a magnetic signal switch, or an electromagnetic signal switch.

In the micro-switch of the invention, operated by the reverse and deflection structures of the switch component, the reverse structure with high rigidity accelerates switching speed of the micro-switch, and the deflection structure with low rigidity reduces required driving power and increases the degree of contact between the terminals such that the invention can accelerate switching speed, reducing operational power, and contact between the terminals are fit better therein.

### BRIEF DESCRIPTION OF THE DRAWINGS

Embodiments of the invention can be more fully understood by reading the subsequent detailed description in conjunction with the examples and references made to the accompanying drawings, wherein:

FIG. 1 is a schematic view of a conventional cantilever micro-switch;

FIG. 2 is a schematic view of a conventional bridge micro-switch;

FIG. 3A is a schematic view of a micro-switch of an embodiment of the invention;

FIG. 3B is a cross section of FIG. 3A along line A-A′;

FIG. 3C is a cross section of FIG. 3A along line B-B′;

FIG. 4 is a schematic view of a micro-switch of another embodiment of the invention;

FIGS. 5A to 5C are local views of a deflection structure of the micro-switch of the invention;

FIGS. 6A to 6B are local views of a reverse structure of the micro-switch of the invention.

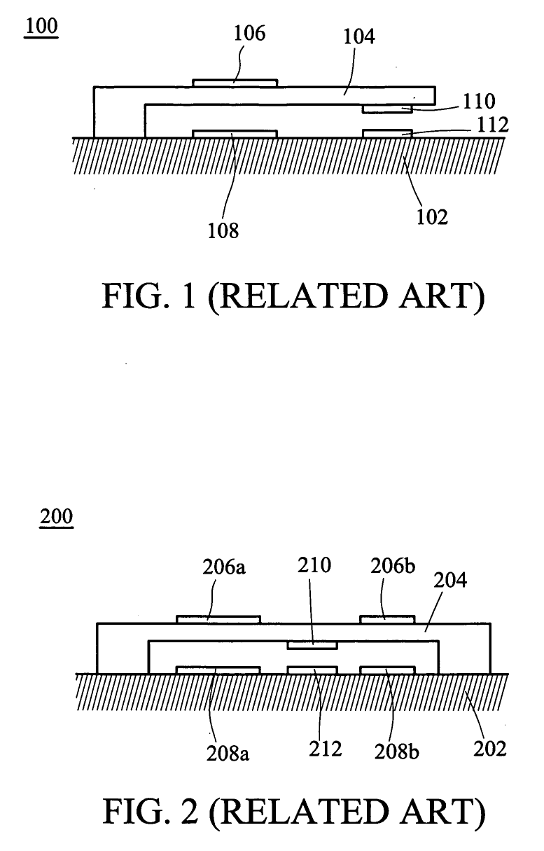

### DETAILED DESCRIPTION

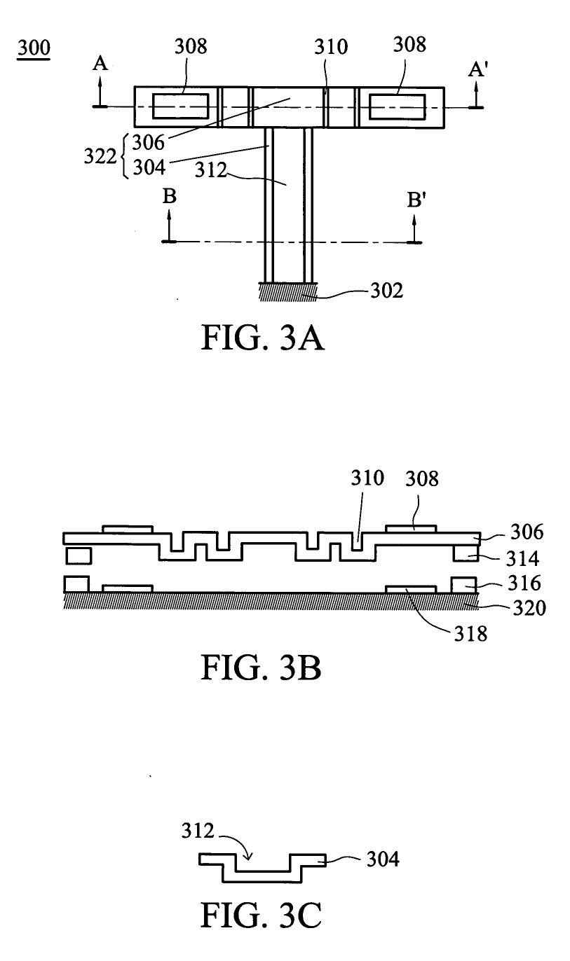

FIG. 3A is a schematic view of a micro-switch 300 of an embodiment of the invention. FIG. 3B is a cross section of FIG. 3A along line A-A′. FIG. 3C is a cross section of FIG. 3A along line B-B′.

As shown in FIGS. 3A, 3B, 3C, the micro-switch 300 comprises a base 320, a fixed portion 320 protruded from the base 320, and a switch component 322. The switch component 322 comprises at least one deflection structure 306 and at least one reverse structure 304. The micro-switch 300 can be an electro-signal switch, a magnetic signal switch, or an electromagnetic signal switch.

The base 320 comprises a terminal 316 and a drive unit 318. The base 320 can be directly disposed on the system or indirectly disposed thereon, or integrated into a unit. The terminal 316 is connected to the system to transmit electrical signals, magnetic signals, and/or electromagnetic signals.

The fixed portion 302 is higher than the base 320 with a side not parallel to the base 320. The fixed portion 320 positions the switch component 322 with a gap between the switch component 322 and the base 320. The fixed portion 302 is directly fixed on the system (not shown or indirectly fixed thereon, or integrated into a unit.

The deflection structure 306 of the switch component 322 comprises at least one terminal 314 and at least one drive unit 308. The terminal 314 corresponds to the terminal 316. The drive unit 308 corresponds to the drive unit 318. One end of the reverse structure 304 of the switch component 322 is connected to a side of the fixed portion 302 with the other end thereof connected to the deflection structure 306. The reverse structure 304 is not parallel to the deflection structure 306. The reverse structure 304 has axial rigidity higher than radial rigidity.

When the drive unit 308 of the deflection structure 306 and the drive unit 318 of the base 320 are electrified, the deflection structure deflects downward. And the reverse structure 304 is reversed by the deflection structure 306 in a moving direction of the drive unit 308. Thus, the deflection structure 306 deflects by rotating, swinging, or both such that the terminals 314 and 316 contact electrically.

According to a principle of physics, an object with high rigidity must have a high restorative force and a low deformable force. Another object with low rigidity must have a low restorative force and a high deformable force. So the conventional micro-switch with single deformable structure cannot simultaneously have a high restorative force and a high deformable force. But the switch of the embodiment of present invention can simultaneously have a high restorative force and a high deformable force by two individual structures.

In the micro-switch 300, the restorative force of the micro-switch 300 is provided by the reverse structure 304, and the deformable force of the micro-switch 300 is provided by the deflection structure 306. So the restorative force and the deformable force of the micro-switch 300 can be high, simultaneously.

In an embodiment, the reverse structure 304 has high rigidity in a length direction of the reverse structure 304, and the deflection structure 306 has low rigidity in a length direction of the deflection structure 306. When the switch 300 is turned on, the drive units 308 and 318 are exerted driving power thereon. Since the deflection structure 306 has low rigidity in the length direction thereof, the terminals 314 and 316 are connected by lower driving power. Thus, electrical signals, magnetic signals, and/or electromagnetic signals are transmitted between the terminals 314 and 316. In this state, the reverse structure 304 is slightly reversed by the deflection structure 306.

When the switch 300 is turned off, the reverse structure 304 can be quickly restored to its original shape by the restorative force thereof. The deflection structure 306 is promptly returned to its original position by the reverse structure 304. Thus, the terminals 314 and 316 are promptly separated.

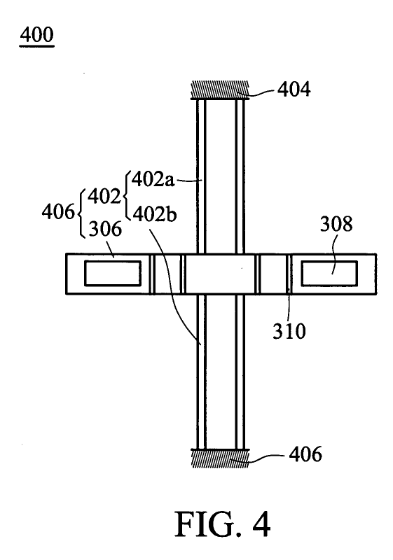

Furthermore, the shape of the switch can be L-shaped or T-shaped as shown in FIG. 3A, or X-shaped, #-shaped, ≠-shaped or arc-shaped, or other shapes. When the switch in FIG. 4 is an X-shaped switch 400, the switch component 406 comprises two reverse structures 402a and 402b fixed on the fixed portions 404 and 406, respectively, providing larger reversed restorative force for the switch component 406.

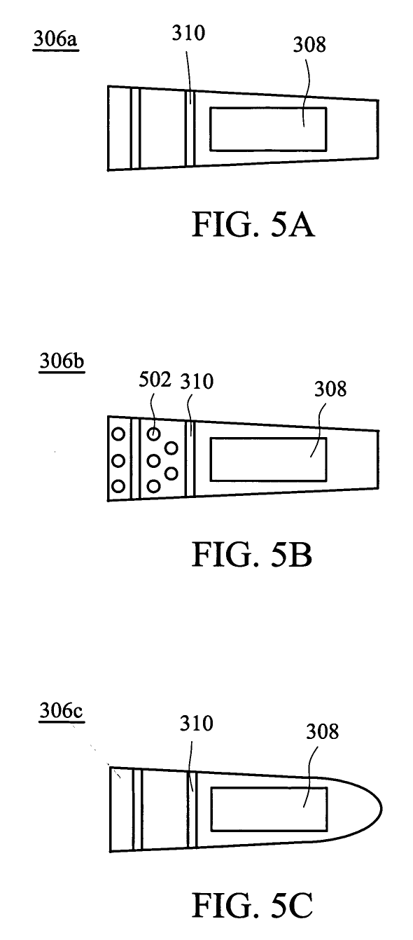

Additionally, the deflection structure 306 can be formed by materials with low rigidity to reduce rigidity. In another embodiment, an auxiliary structure 310 can be formed on the deflection structure 306 to reduce rigidity. The auxiliary structure 310 comprises a groove, a ripple, or, a hole. When the direction of the operating force is perpendicular to the direction of the auxiliary structure 310, the auxiliary structure 310 can significantly reduce the rigidity in the direction of the force. As shown in FIG. 5B, the auxiliary structure 310 has at lest one groove, at lest one ripple, and at lest one hole 502, simultaneously. Thus, rigidity of the deflection structure 306 is further reduced.

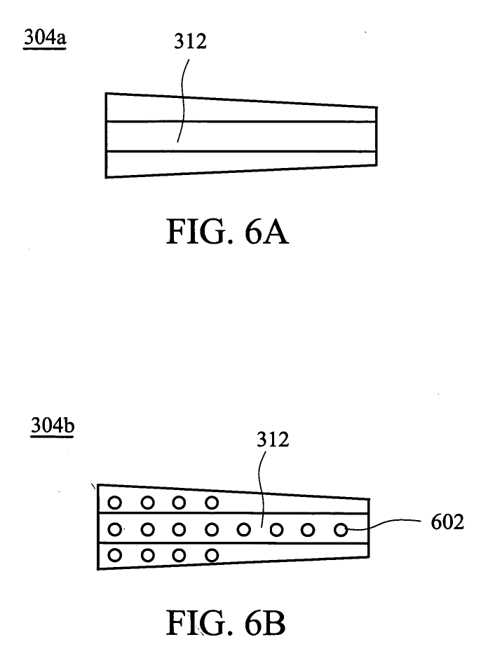

The reverse structure 304 can be formed by materials with high rigidity to increase rigidity. In another embodiment, an auxiliary structure 312 can be formed on the reverse structure 304 to increase rigidity. The auxiliary structure 312 comprises a groove, a ripple, or, a hole. When the direction of the operating force is parallel with the direction of the auxiliary structure 312, the auxiliary structure 312 can significantly increase the rigidity in the direction of the force. As shown in FIG. 6B, the auxiliary structure 312 has at lest one groove, at lest one ripple, and at lest one hole 602, simultaneously. Thus, rigidity of the deflection structure 306 is further increased.

Furthermore, the auxiliary structures 310 and 312 can be a structure with increasing rigidity, a structure with reducing rigidity or a structure with increasing or reducing dynamic stabilization. Moreover, the auxiliary structure can also increase or reduce a damper effect during operation to increase or reduce dynamic stabilization of the switch component.

The cross section of the deflection structure 306 is linear, I-shaped, ripple-shaped, or O-shaped. For example, the deflection structure 306 can be a rectangular deflection structure 306 as shown in FIG. 3A, a polygonal deflection structure such as a trapezoidal deflection structure 306a as shown in FIG. 5B, a round deflection structure, or a polygonal deflection structure 306c with at least one arc-side as shown in FIG. 5C. The cross section of the reverse structure 304 is linear, I-shaped, ripple-shaped, or O-shaped cross section. For example, the reverse structure 304 can be a rectangular reverse structure 304 as shown in FIG. 3A, a polygonal reverse structure such as a trapezoidal reverse structure 304a as shown in FIG. 6A, a round reverse structure 304, or a polygonal reverse structure with at least one arc-side.

When the quantity of deflection structures is two or more than two, as shown in FIG. 3A, the deflection structures are symmetrical, asymmetrical, or partially symmetrical. And the quantity of the reverse structure is two or more than two, the reverse structures are symmetrical, asymmetrical, or partially symmetrical. Moreover, rotating and swinging of the switch component is driven by an electrostatic method in this embodiment; however, the invention is not limited thereto. It can also be driven by electro-thermal method, electromagnetic method, piezoelectric method, or fluid method.

In the micro-switch of the invention, the switch component comprises both reverse and deflection operations. Thus, the reverse operation with high rigidity increases switching speed of the switch component. The deflection operation with low rigidity reduces required operational power and increases degree of contact between the terminals.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A micro-switch, comprising:
at least one base comprising at least one first terminal and at least one first drive unit;
at least one fixed portion protruded from the base; and
at least one switch component comprising:
one deflection structure comprising at least one second terminal and at least one second drive unit, wherein the second terminal corresponds to the first terminal and the second drive unit corresponds to the first drive unit; and
at least one reverse structure comprising one end connected to the fixed portion, and another end connected to the deflection structure.

2. A micro-switch, comprising:
at least one base;
at least one fixed portion protruded from the base; and
at least one switch component comprising:
one deflection structure; and
at least one reverse structure comprising one end connected to the fixed portion, and another end connected to the deflection structure.

3. The micro-switch as claimed in claim 2, wherein the switch component is L-shaped, T-shaped, X-shaped, #-shaped, ≠-shaped, or arc-shaped.

4. The micro-switch as claimed in claim 2, wherein the base comprises at least one first terminal; and the deflection structure comprises at least one second terminal corresponding to the first terminal.

5. The micro-switch as claimed in claim 4, wherein the first terminal contacts the second terminal by rotating, swinging, or simultaneously rotating and swinging the switch component.

6. The micro-switch as claimed in claim 5, wherein the switch component is driven by an electrostatic method, an electro-thermal method, an electromagnetic method, a piezoelectric method, or a fluid method.

7. The micro-switch as claimed in claim 5, wherein when the first terminal contacts the second terminal, at least one electrical signal, magnetic signal, or electromagnetic signal is transmitted between the first terminal and the second terminal.

8. The micro-switch as claimed in claim 2, wherein the switch component further comprises at least one auxiliary structure formed on the deflection structure, the reverse structure, or both.

9. The micro-switch as claimed in claim 8, wherein the auxiliary structure comprises a groove, a ripple, or, a hole.

10. The micro-switch as claimed in claim 2, wherein the deflection structure has a linear, I-shaped, ripple-shaped, or O-shaped cross section.

11. The micro-switch as claimed in claim 2, wherein the reverse structure has a linear, I-shaped, ripple-shaped, or O-shaped cross section.

12. The micro-switch as claimed in claim 2, wherein the shape of the deflection structure is polygonal, round, polygonal with at least one curved side, regular or irregular.

13. The micro-switch as claimed in claim 2, wherein the reverse structure is shaped as polygonal, round, polygonal with at least one curved side, regular or irregular.

14. The micro-switch as claimed in claim 2, wherein when the quantity of the deflection structures is more than two, and the deflection structures are symmetrical, asymmetrical, or partially symmetrical.

15. The micro-switch as claimed in claim 2, wherein when wherein the base comprises at least one first drive unit; and the deflection structure comprises at least one second drive unit corresponding to the first drive unit.

16. The micro-switch as claimed in claim 2, wherein when the quantity of the reverse structures is more than two, the reverse structures are symmetrical, asymmetrical, or partially symmetrical.

17. The micro-switch as claimed in claim 2, wherein when the micro-switch is an electro-signal switch, a magnetic signal switch, or an electromagnetic signal switch.

18. The micro-switch as claimed in claim 2, wherein one side of the fixed portion is not parallel to the base, and the reverse structure comprises an end connected to the side and the other end connected to the deflection structure.

19. The micro-switch as claimed in claim 2, wherein the reverse structure and the deflection structure are not parallel to each other.

20. The micro-switch as claimed in claim 2, wherein the reverse structure is axially connected to the deflection structure.
